(19) United States
(12) Patent Application Publication
(10) Pub. No.: US 2018/0267601 A1
(43) Pub. Date: Sep. 20, 2018

(54) Light Projection for Guiding a User within a Physical User Area During Virtual Reality Operations

(71) Applicant: OCULUS VR, LLC, Menlo Park, CA (US)

(72) Inventor: Youngshik Yoon, Cupertino, CA (US)

(21) Appl. No.: 15/460,192

(22) Filed: Mar. 15, 2017

(51) Int. Cl. G06F 3/01; G06F 1/16; G06T 7/73

(52) U.S. Cl. CPC G06F 3/012; G06F 1/1637; G06T 2207/30244; G06F 1/1686; G06T 7/73; G06F 1/163

(57) ABSTRACT

A method for guiding a user wearing a head-mounted display device with one or more optical sensors includes detecting, with an optical sensor of the one or more optical sensors, light defining a predefined area from one or more light projectors. The method also includes, in conjunction with receiving the light projected from one or more light projectors, providing a signal to a user. A head-mounted display device and a system configured for performing the method are also disclosed.

### TECHNICAL FIELD

This relates generally to display devices, and more specifically to head-mounted display devices.

### BACKGROUND

Head-mounted display devices (also called herein head-mounted displays) are gaining popularity as means for providing visual information to users.

While a user is wearing a head-mounted display device, the user's visual perception of the surroundings can be limited. Therefore, a user wearing a head-mounted display device may unintentionally move outside of a predefined user area. This may lead to interruptions to virtual reality operations (e.g., one or more sensors configured to detect the user's position may no longer detect the user's position or the accuracy in detecting the user's position may be reduced).

### SUMMARY

Accordingly, there is a need for methods and devices that guide users to stay within predefined user areas. The disclosed methods and devices provide to a user a signal indicating that the user (or a head-mounted display device worn by the user) has left, or is about to leave, a predefined user area so that the user can return to, or refrain from leaving, the predefined user area.

In accordance with some embodiments, a method for guiding a user wearing a head-mounted display device with one or more optical sensors is disclosed. The method includes detecting, with an optical sensor of the one or more optical sensors, light defining a predefined area from one or more light projectors, and in conjunction with receiving the light projected from one or more light projectors, providing a signal to the user.

In accordance with some embodiments, a head-mounted display includes an optical sensor configured to detecting light, projected from one or more light projectors, defining a predefined area. The head-mounted display also includes one or more output generators configured to, in conjunction with receiving the light projected from the one or more light projectors, provide a signal to a user.

In accordance with some embodiments, a system includes one or more light projectors projecting light defining a predefined area, and a head-mounted display device described herein.

Thus, the disclosed embodiments provide methods for guiding a user wearing a head-mounted display, and display devices and systems configured for performing such methods.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the figures.

FIG. 1 is a perspective view of a display device in accordance with some embodiments.

FIG. 2 is a block diagram of a system including a display device in accordance with some embodiments.

FIG. 3 is a perspective view of a display device in accordance with some embodiments.

FIGS. 4A-4C are schematic diagrams illustrating top views of a system including a head-mounted display device and light projectors in accordance with some embodiments.

FIGS. 4D and 4E are schematic diagrams illustrating top views of a system including a head-mounted display device and light projectors in accordance with some embodiments.

FIG. 5 is a schematic diagram illustrating a light projector in accordance with some embodiments.

These figures are not drawn to scale unless indicated otherwise.

### DETAILED DESCRIPTION

When a user is wearing a head-mounted display device for virtual reality operations, the user has a limited capability of observing the surrounding environment. Due to the limited visual perception of the surrounding environment, the user may unintentionally move outside of a predefined user area. This may lead to interruptions to virtual reality operations. For example, one or more sensors configured to detect the user's position may no longer detect the user's position or the accuracy in detecting the user's position may be reduced. Additionally, or alternatively, the head-mounted display device may not receive information and/or instructions from other devices.

Thus, there are advantages in keeping a user (and a head-mounted display device worn by the user) within the predefined user area. In some embodiments, a signal is provided to indicate that the head-mounted display device worn by the user has reached or is approaching a boundary of the predefined user area.

The disclosed embodiments provide methods, devices and systems for providing a user with signals upon determination that a head-mounted display device worn by the user has reached or is approaching a boundary of a predefined area.

Reference will now be made to embodiments, examples of which are illustrated in the accompanying drawings. In the following description, numerous specific details are set forth in order to provide an understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It will also be understood that, although the terms first, second, etc. are, in some instances, used herein to describe various elements, these elements should not be limited by these terms. These terms are used only to distinguish one element from another. For example, a first light projector could be termed a second light projector, and, similarly, a second light projector could be termed a first light projector, without departing from the scope of the various described embodiments. The first light projector and the second light projector are both light projectors, but they are not the same light projectors.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. The term “exemplary” is used herein in the sense of “serving as an example, instance, or illustration” and not in the sense of “representing the best of its kind.”

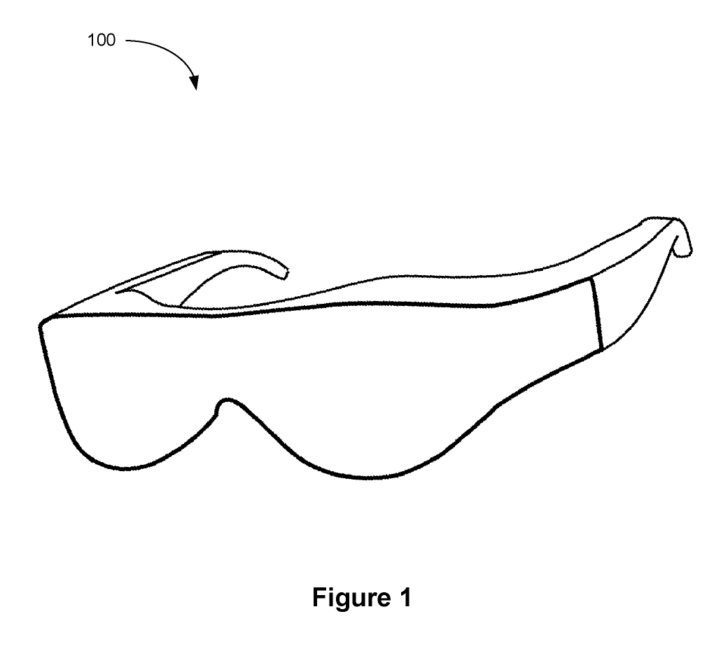

FIG. 1 is a perspective view of a display device in accordance with some embodiments. In some embodiments, display device 100 is configured to be worn on a head of a user (e.g., by having the form of spectacles or eyeglasses, as shown in FIG. 1) or to be included as part of a helmet that is to be worn by the user. When display device 100 is configured to be worn on a head of a user or to be included as part of a helmet, display device 100 is called a head-mounted display.

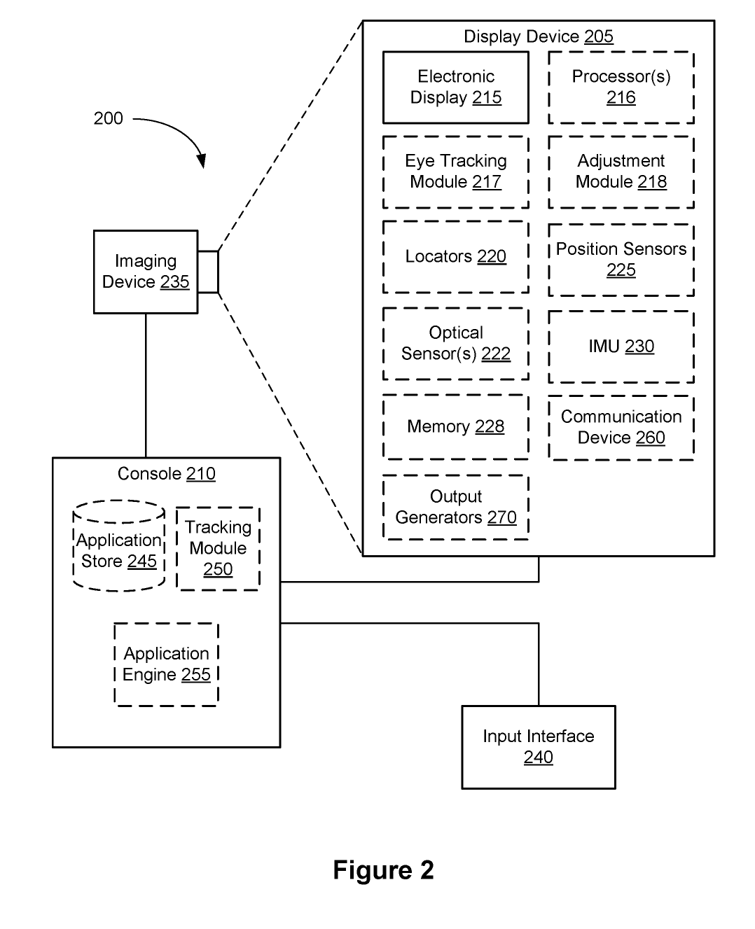

In some embodiments, display device 100 includes one or more components described below with respect to FIG. 2. In some embodiments, display device 100 includes additional components not shown in FIG. 2.

FIG. 2 is a block diagram of a system including a display device in accordance with some embodiments. The system 200 shown in FIG. 2 includes display device 205 (which corresponds to display device 100 shown in FIG. 1), imaging device 235, and input interface 240 that are each coupled to console 210. While FIG. 2 shows an example of system 200 including one display device 205, imaging device 235, and input interface 240, in other embodiments, any number of these components may be included in system 200. For example, there may be multiple display devices 205 each having associated input interface 240 and being monitored by one or more imaging devices 235, with each display device 205, input interface 240, and imaging devices 235 communicating with console 210. In alternative configurations, different and/or additional components may be included in system 200. For example, in some embodiments, console 210 is connected via a network (e.g., the Internet) to system 200 or is self-contained as part of display device 205 (e.g., physically located inside display device 205). In some embodiments, display device 205 is used to create mixed reality by adding in a view of the real surroundings. Thus, display device 205 and system 200 described here can deliver virtual reality, mixed reality, and augmented reality.

In some embodiments, as shown in FIG. 1, display device 205 is a head-mounted display that presents media to a user. Examples of media presented by display device 205 include one or more images, video, audio, tactile feedback or some combination thereof. In some embodiments, audio is presented via an external device (e.g., speakers and/or headphones) that receives audio information from display device 205, console 210, or both, and presents audio data based on the audio information. In some embodiments, tactile feedback is presented via a tactile feedback device (e.g. vibration generation devices) that receives tactile information from display device 205, console 210, or both, and provides tactile feedback based on the audio information. In some embodiments, display device 205 immerses a user in a virtual environment.

In some embodiments, display device 205 also acts as an augmented reality (AR) headset. In these embodiments, display device 205 augments views of a physical, real-world environment with computer-generated elements (e.g., images, video, sound, etc.). Moreover, in some embodiments, display device 205 is able to cycle between different types of operation. Thus, display device 205 operate as a virtual reality (VR) device, an AR device, as glasses or some combination thereof (e.g., glasses with no optical correction, glasses optically corrected for the user, sunglasses, or some combination thereof) based on instructions from application engine 255.

Display device 205 includes electronic display 215, one or more processors 216, eye tracking module 217, adjustment module 218, one or more locators 220, one or more position sensors 225, one or more optical sensors 222, memory 228, inertial measurement unit (IMU) 230, communication device 260, one or more output generators 270 or a subset or superset thereof (e.g., display device 205 with electronic display 215, one or more processors 216, and memory 228, without any other listed components). Some embodiments of display device 205 have different modules than those described here. Similarly, the functions can be distributed among the modules in a different manner than is described here.

One or more processors 216 (e.g., processing units or cores) execute instructions stored in memory 228. Memory 228 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 228, or alternately the non-volatile memory device(s) within memory 228, includes a non-transitory computer readable storage medium. In some embodiments, memory 228 or the computer readable storage medium of memory 228 stores programs, modules and data structures, and/or instructions for displaying one or more images on electronic display 215.

Electronic display 215 displays images to the user in accordance with data received from console 210 and/or processor(s) 216. In various embodiments, electronic display 215 may comprise a single adjustable electronic display element or multiple adjustable electronic displays elements (e.g., a display for each eye of a user).

In some embodiments, the display element includes one or more light emission devices and a corresponding array of emission intensity array. An emission intensity array is an array of electro-optic pixels, opto-electronic pixels, some other array of devices that dynamically adjust the amount of light transmitted by each device, or some combination thereof. These pixels are placed behind one or more lenses. In some embodiments, the emission intensity array is an array of liquid crystal based pixels in an LCD (a Liquid Crystal Display). Examples of the light emission devices include: an organic light emitting diode, an active-matrix organic light-emitting diode, a light emitting diode, some type of device capable of being placed in a flexible display, or some combination thereof. The light emission devices include devices that are capable of generating visible light (e.g., red, green, blue, etc.) used for image generation. The emission intensity array is configured to selectively attenuate individual light emission devices, groups of light emission devices, or some combination thereof. Alternatively, when the light emission devices are configured to selectively attenuate individual emission devices and/or groups of light emission devices, the display element includes an array of such light emission devices without a separate emission intensity array.

One or more lenses direct light from the arrays of light emission devices (optionally through the emission intensity arrays) to locations within each eyebox and ultimately to the back of the user's retina(s). An eyebox is a region that is occupied by an eye of a user located proximity to display device 205 (e.g., a user wearing display device 205) for viewing images from display device 205. In some cases, the eyebox is represented as a 10 mm×10 mm square. In some embodiments, the one or more lenses include one or more coatings, such as anti-reflective coatings.

In some embodiments, the display element includes an infrared (IR) detector array that detects IR light that is retro-reflected from the retinas of a viewing user, from the surface of the corneas, lenses of the eyes, or some combination thereof. The IR detector array includes an IR sensor or a plurality of IR sensors that each correspond to a different position of a pupil of the viewing user's eye. In alternate embodiments, other eye tracking systems may also be employed.

Eye tracking module 217 determines locations of each pupil of a user's eyes. In some embodiments, eye tracking module 217 instructs electronic display 215 to illuminate the eyebox with IR light (e.g., via IR emission devices in the display element).

A portion of the emitted IR light will pass through the viewing user's pupil and be retro-reflected from the retina toward the IR detector array, which is used for determining the location of the pupil. Alternatively, the reflection off of the surfaces of the eye is used to also determine location of the pupil. The IR detector array scans for retro-reflection and identifies which IR emission devices are active when retro-reflection is detected. Eye tracking module 217 may use a tracking lookup table and the identified IR emission devices to determine the pupil locations for each eye. The tracking lookup table maps received signals on the IR detector array to locations (corresponding to pupil locations) in each eyebox. In some embodiments, the tracking lookup table is generated via a calibration procedure (e.g., user looks at various known reference points in an image and eye tracking module 217 maps the locations of the user's pupil while looking at the reference points to corresponding signals received on the IR tracking array). As mentioned above, in some embodiments, system 200 may use other eye tracking systems than the embedded IR one described above.

Adjustment module 218 generates an image frame based on the determined locations of the pupils. In some embodiments, this sends a discrete image to the display that will tile subimages together thus a coherent stitched image will appear on the back of the retina. Adjustment module 218 adjusts an output (i.e. the generated image frame) of electronic display 215 based on the detected locations of the pupils. Adjustment module 218 instructs portions of electronic display 215 to pass image light to the determined locations of the pupils. In some embodiments, adjustment module 218 also instructs the electronic display to not pass image light to positions other than the determined locations of the pupils. Adjustment module 218 may, for example, block and/or stop light emission devices whose image light falls outside of the determined pupil locations, allow other light emission devices to emit image light that falls within the determined pupil locations, translate and/or rotate one or more display elements, dynamically adjust curvature and/or refractive power of one or more active lenses in the lens (e.g., microlens) arrays, or some combination thereof.

Optional locators 220 are objects located in specific positions on display device 205 relative to one another and relative to a specific reference point on display device 205. A locator 220 may be a light emitting diode (LED), a corner cube reflector, a reflective marker, a type of light source that contrasts with an environment in which display device 205 operates, or some combination thereof. In embodiments where locators 220 are active (i.e., an LED or other type of light emitting device), locators 220 may emit light in the visible band (e.g., about 400 nm to 750 nm), in the infrared band (e.g., about 750 nm to 1 mm), in the ultraviolet band (about 100 nm to 400 nm), some other portion of the electromagnetic spectrum, or some combination thereof.

In some embodiments, locators 220 are located beneath an outer surface of display device 205, which is transparent to the wavelengths of light emitted or reflected by locators 220 or is thin enough to not substantially attenuate the wavelengths of light emitted or reflected by locators 220. Additionally, in some embodiments, the outer surface or other portions of display device 205 are opaque in the visible band of wavelengths of light. Thus, locators 220 may emit light in the IR band under an outer surface that is transparent in the IR band but opaque in the visible band.

IMU 230 is an electronic device that generates calibration data based on measurement signals received from one or more position sensors 225. Position sensor 225 generates one or more measurement signals in response to motion of display device 205. Examples of position sensors 225 include: one or more accelerometers, one or more gyroscopes, one or more magnetometers, another suitable type of sensor that detects motion, a type of sensor used for error correction of IMU 230, or some combination thereof. Position sensors 225 may be located external to IMU 230, internal to IMU 230, or some combination thereof.

Based on the one or more measurement signals from one or more position sensors 225, IMU 230 generates first calibration data indicating an estimated position of display device 205 relative to an initial position of display device 205. For example, position sensors 225 include multiple accelerometers to measure translational motion (forward/back, up/down, left/right) and multiple gyroscopes to measure rotational motion (e.g., pitch, yaw, roll). In some embodiments, IMU 230 rapidly samples the measurement signals and calculates the estimated position of display device 205 from the sampled data. For example, IMU 230 integrates the measurement signals received from the accelerometers over time to estimate a velocity vector and integrates the velocity vector over time to determine an estimated position of a reference point on display device 205. Alternatively, IMU 230 provides the sampled measurement signals to console 210, which determines the first calibration data. The reference point is a point that may be used to describe the position of display device 205. While the reference point may generally be defined as a point in space; however, in practice the reference point is defined as a point within display device 205 (e.g., a center of IMU 230).

In some embodiments, IMU 230 receives one or more calibration parameters from console 210. As further discussed below, the one or more calibration parameters are used to maintain tracking of display device 205. Based on a received calibration parameter, IMU 230 may adjust one or more IMU parameters (e.g., sample rate). In some embodiments, certain calibration parameters cause IMU 230 to update an initial position of the reference point so it corresponds to a next calibrated position of the reference point. Updating the initial position of the reference point as the next calibrated position of the reference point helps reduce accumulated error associated with the determined estimated position. The accumulated error, also referred to as drift error, causes the estimated position of the reference point to “drift” away from the actual position of the reference point over time.

In some embodiments, display device 205 includes one or more optical sensors 222 (e.g., one, two, three, four or more optical sensors). In some embodiments, one or more optical sensors 222 include one or more still cameras, one or more video cameras, other devices capable of capturing images, one or more photodiodes, other devices capable of detecting intensity of light, or some combination thereof. In some embodiments, optical sensors 222 further include one or more optical components, such as one or more filters, shutters, diaphragms, lenses, other optical components and/or some combination thereof.

In some embodiments, display device 205 includes communication device 260 (e.g. a wireless communication device). In some embodiments, communication device 260 transmits and receives information and/or instructions to and from console 210.

In some embodiments, display device 205 includes one or more output generators 270 (e.g., an audio output generator, a tactile output generator, and/or a display device). In some embodiments, display device 205 is in communication with one or more external output generators (e.g., display device 205 communicates with one or more output generators that are distinct and separate from display device 205, such as a wireless headphone).

Imaging device 235 generates calibration data in accordance with calibration parameters received from console 210. Calibration data includes one or more images showing observed positions of locators 220 that are detectable by imaging device 235. In some embodiments, imaging device 235 includes one or more still cameras, one or more video cameras, any other device capable of capturing images including one or more locators 220, or some combination thereof. Additionally, imaging device 235 may include one or more filters (e.g., used to increase signal to noise ratio). Imaging device 235 is configured to optionally detect light emitted or reflected from locators 220 in a field of view of imaging device 235. In embodiments where locators 220 include passive elements (e.g., a retroreflector), imaging device 235 may include a light source that illuminates some or all of locators 220, which retro-reflect the light towards the light source in imaging device 235. Second calibration data is communicated from imaging device 235 to console 210, and imaging device 235 receives one or more calibration parameters from console 210 to adjust one or more imaging parameters (e.g., focal length, focus, frame rate, ISO, sensor temperature, shutter speed, aperture, etc.).

Input interface 240 is a device that allows a user to send action requests to console 210. An action request is a request to perform a particular action. For example, an action request may be to start or end an application or to perform a particular action within the application. Input interface 240 may include one or more input devices. Example input devices include: a keyboard, a mouse, a game controller, data from brain signals, data from other parts of the human body, or any other suitable device for receiving action requests and communicating the received action requests to console 210. An action request received by input interface 240 is communicated to console 210, which performs an action corresponding to the action request. In some embodiments, input interface 240 may provide haptic feedback to the user in accordance with instructions received from console 210. For example, haptic feedback is provided when an action request is received, or console 210 communicates instructions to input interface 240 causing input interface 240 to generate haptic feedback when console 210 performs an action.

Console 210 provides media to display device 205 for presentation to the user in accordance with information received from one or more of: imaging device 235, display device 205, and input interface 240. In the example shown in FIG. 2, console 210 includes application store 245, tracking module 250, and application engine 255. Some embodiments of console 210 have different modules than those described in conjunction with FIG. 2. Similarly, the functions further described below may be distributed among components of console 210 in a different manner than is described here.

When application store 245 is included in console 210, application store 245 stores one or more applications for execution by console 210. An application is a group of instructions, that when executed by a processor, is used for generating content for presentation to the user. Content generated by the processor based on an application may be in response to inputs received from the user via movement of display device 205 or input interface 240. Examples of applications include: gaming applications, conferencing applications, video playback application, or other suitable applications.

When tracking module 250 is included in console 210, tracking module 250 calibrates system 200 using one or more calibration parameters and may adjust one or more calibration parameters to reduce error in determination of the position of display device 205. For example, tracking module 250 adjusts the focus of imaging device 235 to obtain a more accurate position for observed locators on display device 205. Moreover, calibration performed by tracking module 250 also accounts for information received from IMU 230. Additionally, if tracking of display device 205 is lost (e.g., imaging device 235 loses line of sight of at least a threshold number of locators 220), tracking module 250 re-calibrates some or all of system 200.

In some embodiments, tracking module 250 tracks movements of display device 205 using second calibration data from imaging device 235. For example, tracking module 250 determines positions of a reference point of display device 205 using observed locators from the second calibration data and a model of display device 205. In some embodiments, tracking module 250 also determines positions of a reference point of display device 205 using position information from the first calibration data. Additionally, in some embodiments, tracking module 250 may use portions of the first calibration data, the second calibration data, or some combination thereof, to predict a future location of display device 205. Tracking module 250 provides the estimated or predicted future position of display device 205 to application engine 255.

Application engine 255 executes applications within system 200 and receives position information, acceleration information, velocity information, predicted future positions, or some combination thereof of display device 205 from tracking module 250. Based on the received information, application engine 255 determines content to provide to display device 205 for presentation to the user. For example, if the received information indicates that the user has looked to the left, application engine 255 generates content for display device 205 that mirrors the user's movement in a virtual environment. Additionally, application engine 255 performs an action within an application executing on console 210 in response to an action request received from input interface 240 and provides feedback to the user that the action was performed. The provided feedback may be visual or audible feedback via display device 205 or haptic feedback via input interface 240.

In some embodiments, system 100 additionally includes one or more light projectors (e.g. one, two, three, four, five, six or more). In some embodiments, the light projectors project light to define boundaries of a predefined area.

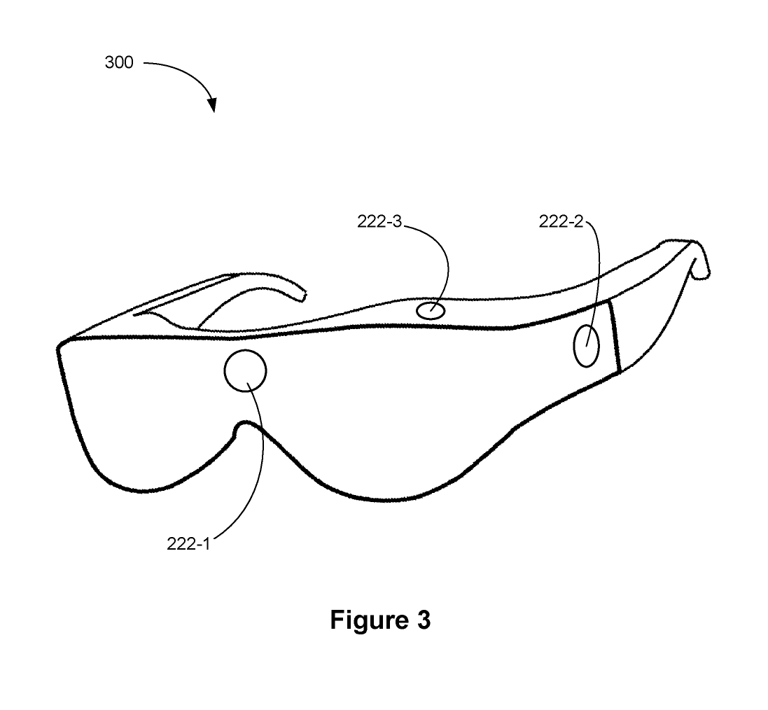

FIG. 3 is a perspective view of display device 300 in accordance with some embodiments. Display device 300 corresponds to display device 100, except that display device 300 has optical sensors 222-1, 222-2, and/or 222-3. Optical sensors 222-1, 222-2, and 222-3 correspond to optical sensors 222 of display device 205. In some embodiments, optical sensors 222-1, 222-2, and/or 222-3 are cameras (e.g., one or more still cameras, one or more video cameras, or any other device capable of capturing images), photodiodes, other devices capable of measuring light intensity and/or some combination thereof. In some embodiments, optical sensors 222-1, 222-2, and 222-3 further include one or more filters for defining a light detected by optical sensors 222-1, 222-2, and 222-3. In some embodiments, optical sensors 222-1, 222-2, and 222-3 are positioned on a front outer surface, side outer surfaces, and/or a top outer surface of display device 300. In some embodiments, optical sensors 222-1, 222-2, and 222-3 are positioned beneath an outer surface of display device 205, which is transparent to the wavelengths of light emitted by light projectors, as described in relation to FIG. 2. Although FIG. 3 illustrates display device 300 with optical sensors 222-1, 222-2, and 222-3, display device 300 may have fewer optical sensors (e.g., optical sensor 222-1 only, optical sensor 222-2 only, optical sensor 222-3 only, or any combination thereof) or more optical sensors (e.g., two or more optical sensors on a front surface, two or more optical sensors on side surfaces, and/or two or more optical sensors on a top surface).

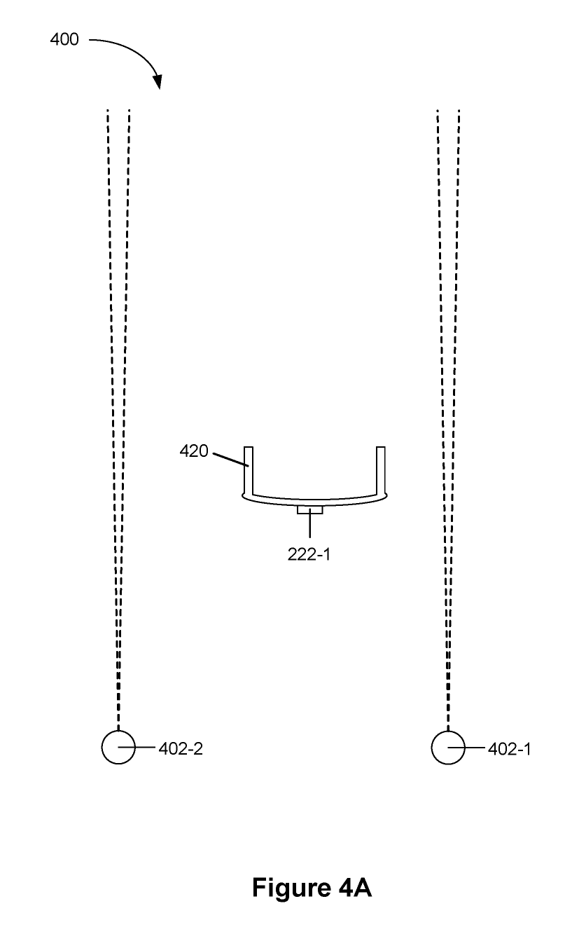

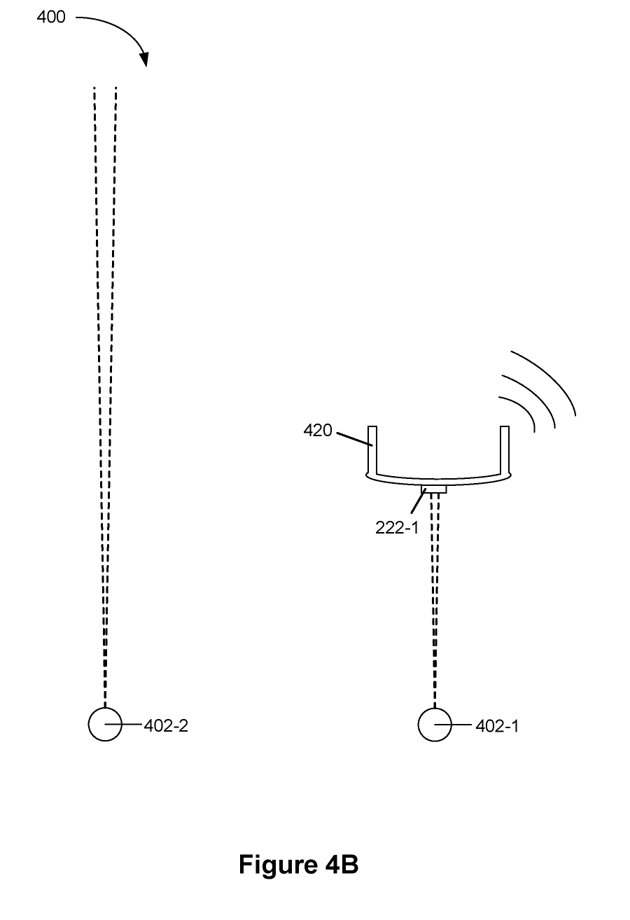

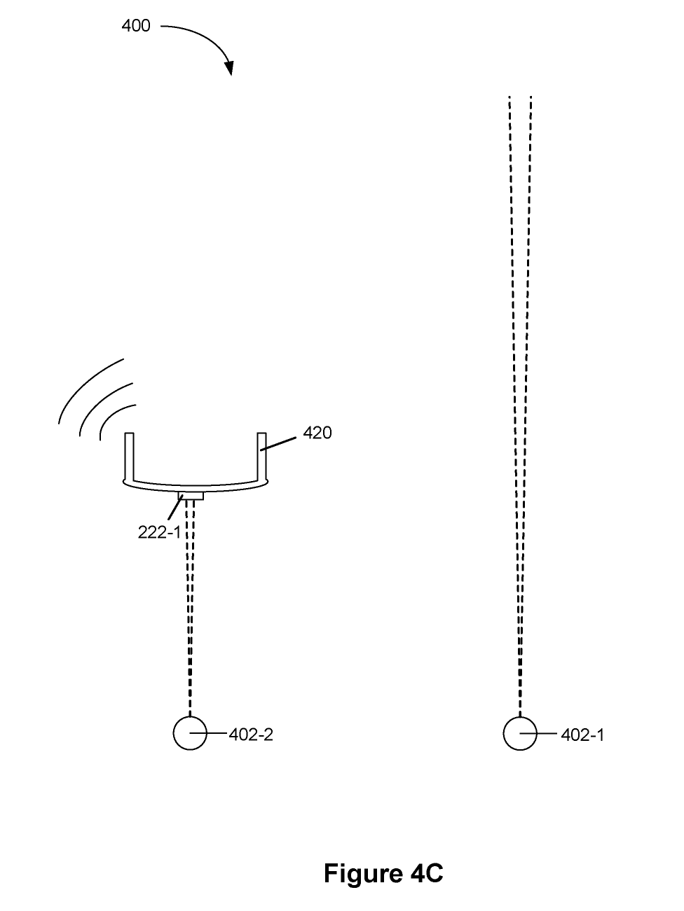

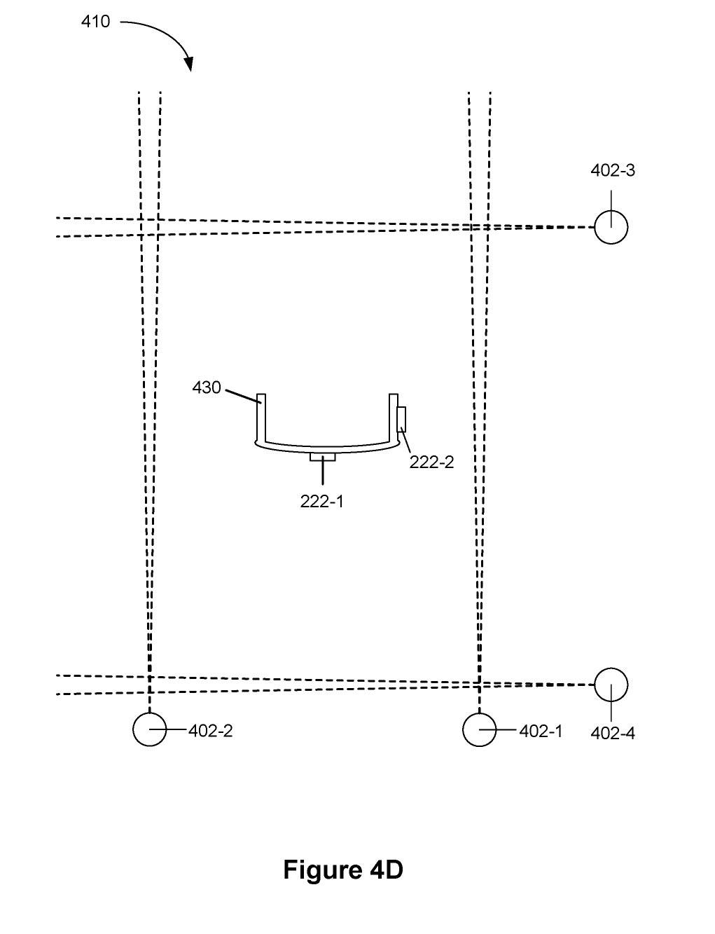

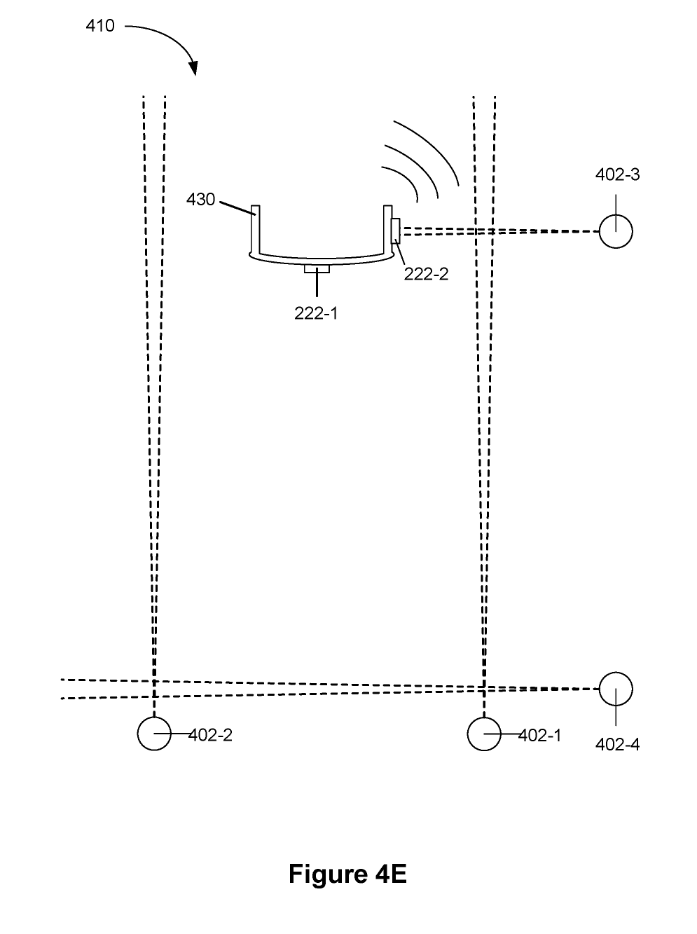

FIGS. 4A-4C are schematic diagrams illustrating top views of system 400 including a head-mounted display device and light projectors in accordance with some embodiments.

In FIG. 4A, system 400 includes display device 420 and light projectors 402-1 and 402-2. Display device 420 corresponds to display device 300 with optical sensor 222-1. In some embodiments, system 400 also includes other components of system 200 (e.g., imaging device 235 and/or console 210).

Each of light projectors 402-1 and 402-2 includes one or more light sources. In some embodiments, the one or more light sources include one or more lasers, one or more light emitting diodes (LEDs), other light projecting devices or some combination thereof. Light projected by the one or more light sources is detected by optical sensor 222-1. In some embodiments, optical sensor 222-1 detects light projected by projector 402-1 or 402-2 based on the intensity and/or wavelength of the light (e.g., optical sensor 222-1 is coupled with an optical filter to distinguish the wavelength of the light). In some embodiments, the projected light has a distinct wavelength. Light with a distinct wavelength refers to light that is distinguished from the ambient light (e.g., outdoor lighting such as sun light, and/or indoor lighting) by optical sensor 222-1. For example, projector 402-1 projects a green light which is distinguished from the ambient light by optical sensor 222-1.

In FIGS. 4A-4C, light projector 402-1 projects light defining a first boundary of a predefined area, and light projector 402-2 projects light defining a second boundary of the predefined area that is distinct from the first boundary of the predefined area. As shown in FIGS. 4A-4C, the predefined area need not be a closed area (e.g., the left and right boundaries of the predefined area are defined but the front and rear boundaries of the predefined area are not defined).

In FIG. 4A, the first boundary and the second boundary are parallel to each other. In some embodiments, the first boundary and the second boundary are not parallel to each other. For example, in some embodiments, the first and second boundaries define an angle ranging from about 10 degrees to about 90 degrees (e.g., about 10, 20, 30, 40, 50, 60, 70, 80 or about 90 degrees).

In some embodiments, light projectors 402-1 and 402-2 are positioned at a suitable height so that they are in the field of view of optical sensor 222-1. In some embodiments, light projectors 222-1 and 222-2 are positioned approximately at the same level as display device 420.

In FIG. 4A, display device 420 is positioned between the first boundary and the second boundary of the predefined area.

In FIG. 4B, display device 420 has reached the first boundary, of the predefined area, defined by light projected by light projector 402-1, and the optical sensor 222-1 of display device 420 detects light from light projector 402-1 (e.g., the light from light projector 402-1 is within the field of view of optical sensor 222-1 when display device 420 has reached the first boundary).

In some embodiments, optical sensor 222-1 detects the intensity and/or the wavelength of the projected light. In some embodiments, the information regarding the detected intensity and/or the wavelength of the projected light is communicated to one or more processors 216 of display device 420 and one or more processors 216 determine whether display device 420 has reached the first boundary of the predefined area based on the intensity and/or wavelength information. In accordance with a determination that display device 420 has reached the first boundary of the predefined area, display device 420 provides a signal to the user (e.g., an audio signal, a visual signal, and/or a tactile feedback).

In some embodiments, display device 420 includes one or more output generators (e.g., output generators 270 including an audio output generator, such as a speaker, and/or a tactile output generator). In some embodiments, the signal is a visual signal generated by electronic display 215, an audio signal or a tactile signal (e.g. vibration) generated by output generators 270 or any combination thereof. In such embodiments, providing the signal to the user includes sending information and/or instructions to the one or more output generators, initiating the one or more output generators to generate the signal for presentation to the user. In some embodiments, display device 420 is in communication with one or more external output generators (e.g., display device 420 communicates with one or more output generators that are distinct and separate from display device 420, such as a wireless headphone). In such embodiments, the information and/or instructions to the one or more external output generators are sent via communication device 260 (e.g. a wireless communication device).

In some embodiments, the intensity and/or wavelength information is transmitted to console 210, shown in FIG. 2. In some embodiments, console 210 determines whether display device 420 has reached the first boundary of the predefined area. In some embodiments, in accordance with a determination that display device 420 has reached the first boundary of the predefined area, console 210 sends information and/or instructions to display device 420 for providing a signal to the user accordingly. In some embodiments, in accordance with a determination that display device 420 has reached the first boundary of the predefined area, console 210 initiates providing a signal to the user without transmitting the information and/or instructions to display device 420. For example, console transmits the information and/or instructions to the one or more external output generators directly.

In FIG. 4C, display device 420 has reached the second boundary of a predefined area, defined by light projected by light projector 402-2, and the optical sensor 222-1 of display device 420 detects light from light projectors 402-2 (e.g., the light from light projector 402-2 is within the field of view of optical sensor 222-1 when display device 420 has reached the second boundary).

In some embodiments, optical sensor 222-1 detects the intensity and/or the wavelength of the projected light. As described above with respect to FIG. 4B, in some embodiments, the information regarding the detected intensity and/or the wavelength of the projected light is communicated to one or more processor 216 of display device 420 and one or more processors 216 determine whether display device 420 has reached the second boundary of a predefined area based on the intensity and/or wavelength information. In accordance with a determination that display device 420 has reached the second boundary of the predefined area, display device 420 provides a signal to the user. In some embodiments, the signal provided in accordance with a determination that display device 420 has reached the second boundary of the predefined area is distinct from the signal provided in accordance with a determination that display device 420 has reached the first boundary of the predefined area (e.g., display device 420 provides a first audio feedback when display device 420 reaches the first boundary and provides a second audio feedback distinct from the first audio feedback when display device 420 reaches the second boundary).

Although FIGS. 4A-4C illustrate a system with two light projectors, fewer (e.g., one light projector) or more light projectors can be used.

FIGS. 4D-4E are schematic diagrams illustrating top views of system 410 including display device 430 and light projectors 402-1, 402-2, 402-3, and 402-4. Display device 430 corresponds to display device 300 with optical sensors 222-1 and 222-2.

In some embodiments, light projectors 402-3 and 402-4 are configured similarly to light projectors 402-1 and 402-2, and the detailed description of the configuration of light projectors 402-3 and 402-4 is omitted herein for brevity.

In FIGS. 4D-4E, light projector 402-1 projects light defining a first boundary of a predefined area, and light projector 402-2 projects light defining a second boundary of the predefined area that is distinct from the first boundary of the predefined area, as described above with respect to FIGS. 4A-4C. In addition, light projector 402-3 projects light defining a third boundary of the predefined area that is distinct from the first boundary and the second boundary of the predefined area, and light projector 402-4 projects light defining a fourth boundary of the predefined area that is distinct from the first boundary, the second boundary, and the third boundary of the predefined area.

In some embodiments, the third boundary and the fourth boundary are parallel to each other. In some embodiments, the third boundary and the fourth boundary are not parallel to each other. For example, in some embodiments, the third and fourth boundaries define an angle ranging from about 10 degrees to about 90 degrees (e.g., about 10, 20, 30, 40, 50, 60, 70, 80 or about 90 degrees).

In FIGS. 4D-4E, the predefined area has a rectangular shape. In some embodiments, the predefined area has a shape of a triangle, rectangle, square, polygon, circle, ellipse or any other shape. In some embodiments, the predefined area is defined by the user. In some embodiments, the predefined area is defined for the media presented by the head-mounted display.

In FIG. 4D, display device 430 is positioned between the first boundary and the second boundary of the predefined area, and between the third boundary and the fourth boundary of the predefined area.

In FIG. 4E, display device 430 has reached the third boundary of the predefined area defined by light from light projector 402-3 (e.g., the light from light projector 402-3 is within the field of view of optical sensor 222-2 when display device 430 has reached the third boundary).

In some embodiments, optical sensor 222-2 is configured to detect the intensity and/or the wavelength of the projected light. As described above with respect to FIG. 4B, the information regarding the detected intensity and/or the wavelength of the projected light is used for determining whether the display device 430 has reached a particular boundary (e.g., the third boundary). In accordance with a determination that display device 430 has reached the third boundary, display device 430 provides a signal to the user.

In some embodiments, the signal provided in accordance with determining that display device 430 has reached the first boundary of the predefined area is the same as the signal provided in response to determining that display device 430 has reached the second or third boundary of the predefined area. In some embodiments, the signal provided in accordance with determining that display device 430 has reached the first boundary is distinct from the signal provided in accordance with determining that display device 430 has reached the second or third boundary of the predefined area. In some embodiments, the signal provided in accordance with determining that display device 430 has reached the second boundary is distinct from the signal provided in accordance with determining that display device 430 has reached the third boundary of the predefined area. In such embodiments, the signal is used to identify a position of display device 430. For example, the signal can indicate whether display device 430 has reached the first boundary, the second boundary, the third boundary, or the fourth boundary (e.g., each boundary is associated with a distinct signal or a distinct combination of signals, such as audio, video, and tactile signals).

In some embodiments, display device 430 reaches the fourth boundary of the predefined area defined by light from light projector 402-4 (e.g., the light from light projector 402-4 is within the field of view of optical sensor 222-2 when display device 430 has reached the fourth boundary). In accordance with a determination that display device 430 has reached the fourth boundary, display device 430 provides a signal to the user.

In some embodiments, the signal provided in accordance with determining that display device 430 has reached the fourth boundary of the predefined area is the same as the signal provided in response to determining that display device 430 has reached the third boundary of the predefined area. In some embodiments, the signal provided in accordance with determining that display device 430 has reached the fourth boundary is distinct from the signal provided in accordance with determining that display device 430 has reached the third boundary of the predefined area.

In some embodiments, the signal provided to the user indicates that display device 430 is approaching a boundary of the predefined area. For example, display device 430 provides a signal indicating that display device 430 is within a certain distance from a boundary (e.g. 1 foot, ½ foot, ¼ foot, etc. from the boundary). In some embodiments, the distance from the boundary is determined based on the intensity of the light projected by the respective light projector and detected by an optical sensor.

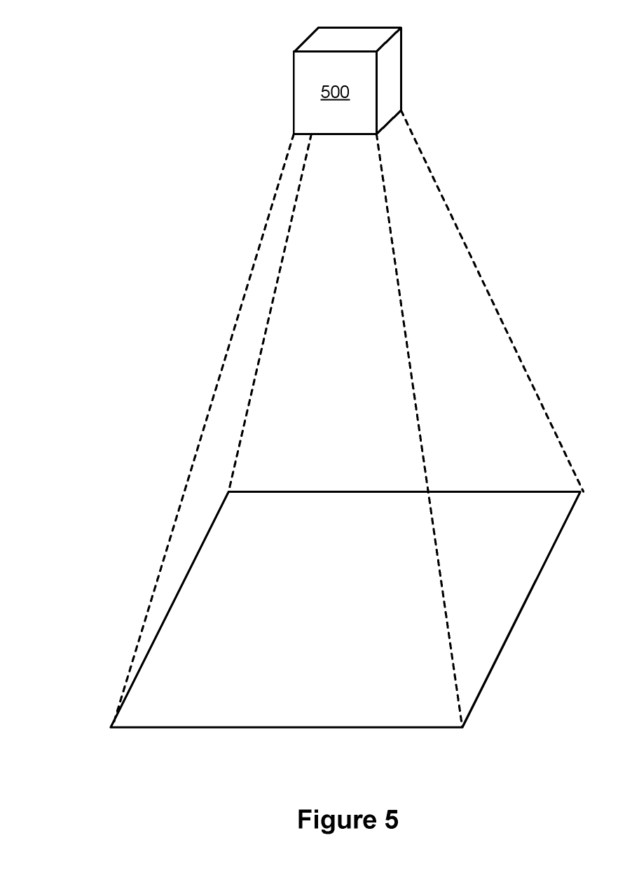

FIG. 5 is a schematic diagram illustrating a light projector in accordance with some embodiments.

In some embodiments, light projector 500 includes one or more light sources. In some embodiments, the one or more light sources include one or more lasers, one or more light emitting diodes (LEDs), other light projecting devices or some combination thereof. In some embodiments, light projector 500 includes one or more beam shaping optics. In some embodiments, light projector 500 projects light to fill the predefined area. In some embodiments, light projector 500 projects light along a boundary of the predefined area (but not toward a middle of the predefined area). In some embodiments, light projector 500 is positioned above display device 300 (e.g., light projector 500 is mounted on a ceiling) and projects light downward.

In FIG. 5, light projector 500 projects light defining a rectangular predefined area. In some embodiments, the predefined area defined by light projected by light projector 500 has a triangle, rectangle, square, polygon, circle, ellipse or any other shape.

Light projected by the one or more light sources is detected by optical sensor 222-3 mounted on a top surface of a display device. In some embodiments, optical sensor 222-3 detects light projected by projector 500 based on the intensity and/or wavelength of the light (e.g., optical sensor 222-3 is coupled with an optical filter to distinguish the wavelength of the light). In some embodiments, the projected light has a distinct wavelength.

In some embodiments, light projector 500 is used in conjunction with any of light projectors 402-1, 402-2, 402-3, and 402-4. In some embodiments, multiple light projectors located above display device 300 are used.

In view of these principles, we now turn to certain embodiments.

In accordance with some embodiments, a method for guiding a user wearing a head-mounted display device (e.g., display device 420 in FIG. 4A) with one or more optical sensors (e.g., optical sensor 222-1) includes detecting, with an optical sensor of the one or more optical sensors, light defining a predefined area from one or more light projectors (e.g., optical sensor 222-1 detects light from light projector 402-2 as shown in FIG. 4B). The method also includes, in conjunction with detecting the light projected from one or more light projectors, providing a signal to a user (e.g., in accordance with a determination that optical sensor 222-1 detects light from light projector 402-1 and/or in response to determining that optical sensor 222-1 detects light from light projector 402-1, display device 420 provides an audio signal, a visual signal, and/or a haptic signal, such as vibration of display device 420).

In some embodiments, the display device (e.g., display device 420) includes one or more output generators (e.g., output generators 270, such as an audio output generator, and/or a tactile output generator), and a display device (e.g., electronic display 215). In some embodiments, display device 420 is in communication with one or more external output generators (e.g., display device 420 communicates with one or more output generators that are distinct and separate from display device 420, such as a wireless headphone). In such embodiments, providing the signal to the user includes sending information and/or instructions to the one or more output generators, initiating the one or more output generators to generate the signal for presentation to the user.

In some embodiments, the method includes projecting the light defining the predefined area using the one or more light projectors (e.g., light projectors 402-1 and 402-2 define a predefined area as shown in FIG. 4A).

In some embodiments, the method includes projecting a first light from a first light projector of the one or more light projectors and projecting a second light from a second light projector of the one or more light projectors. The second light projector is distinct from the first light projector. The first light defines a first boundary of the predefined area defining and the second light defines a second boundary of the predefined area, which is distinct from the first boundary. For example, in FIG. 4A, light projector 402-1 projects light that defines the first boundary of the predefined area, and light projector 402-2 projects light that defines the second boundary, distinct from the first boundary, of the predefined area.

In some embodiments, the method includes detecting with the one or more optical sensors the first light defining the first boundary of the predefined area (e.g., optical sensor 222-1 detects light emitted by projector 402-1, as shown in FIG. 4B). The method also includes, in response to detecting the first light defining the first boundary of the predefined area, providing a first signal to the user. The method further includes detecting with the one or more optical sensors, the second light defining the second boundary of the predefined area (e.g., optical sensor 222-1 detects light emitted by light projector 402-2, as shown in FIG. 4C). The method further includes, in response to detecting the second light defining the second boundary of the predefined area, providing to the user a second signal that is distinct from the first signal. For example, as shown in FIGS. 4B and 4C, in accordance with a determination that optical sensor 222-1 detects light from light projector 402-1, display device 420 provides a first signal (e.g., an audio signal or a haptic feedback on a left-side of the display device) to the user indicating that the user has reached the first boundary (e.g., a left boundary), and in accordance with a determination that optical sensor 222-1 detects light from light projector 402-2, display device 420 provides a second signal (e.g., an audio signal or a haptic feedback on a right-side of the display device) to the user indicating that the user has reached the second boundary.

In some embodiments, the method includes projecting a third light from a third light projector of the one or more light projectors defining a third boundary. The third light projector is distinct from the first light projector and the second light projector, and the third boundary is distinct from the first boundary and the second boundary, of the predefined area. For example, as shown in FIG. 4A, light projector 402-3 projects light which defines the third boundary of the predefined area, which is distinct from the boundaries defined by light from light projectors 402-1 and 402-2.

In some embodiments, the method includes projecting a first light from a first light projector of the one or more light projectors defining a first boundary of the predefined area, and projecting a third light from a third light projector of the one or more light projectors defining a third boundary of the predefined area (e.g., FIG. 4D). The third light projector is distinct from the first light projector and the third boundary is distinct from the first boundary. The method also includes detecting with a first optical sensor of the one or more optical sensors the first light defining the first boundary of the predefined area, and in response to detecting the first light defining the first boundary of the predefined area, providing a first signal to the user (e.g., FIG. 4B). The method further includes detecting with a second optical sensor of the one or more optical sensors, distinct from the first optical sensor, the third light defining the third boundary of the predefined area and in response to detecting the third light defining the third boundary of the predefined area, providing a third signal to a user (e.g., FIG. 4E).

In some embodiments, the method includes determining that the head-mounted display device has reached a boundary of the predefined area (e.g., determining that display device 420 has reached the first boundary of the predefined area as shown in FIG. 4B).

In some embodiments, the method includes determining that the head-mounted display device has reached the boundary of the predefined area based on an intensity of the light from the one or more light projectors (e.g., a determination that display device 420 has reached the first boundary of the predefined area, as shown in FIG. 4B, is made based on the intensity of light from light projector 402-1, such as the intensity of the detected light exceeding a predefined intensity threshold).

In some embodiments, the method includes determining that the head-mounted display device has reached the boundary of the predefined area based on one or more wavelengths of the light from the one or more light projectors (e.g., a determination that display device 420 has reached the first boundary of the predefined area, as shown in FIG. 4B, is made based on the wavelength of light from light projector 402-1, such as comparing a peak wavelength of the detected light with a reference wavelength of light from light projector 402-1). For example, in response to detecting light of a first color, the display device determines that the display device has reached the first boundary of the predefined area; in response to detecting light of a second color distinct from the first color, the display device determines that the display device has reached the second boundary of the predefined area; in response to detecting light of a third color distinct from the first color and the second color, the display device determines that the display device has reached the third boundary of the predefined area; in response to detecting light of a fourth color distinct from the first color, the second color, and the third color, the display device determines that the display device has reached the fourth boundary of the predefined area.

In accordance with some embodiments, a head-mounted display device (e.g., display device 205, as shown in FIG. 2) includes an optical sensor (e.g., one or more optical sensors 222) configured to detect light, projected from one or more light projectors defining a predefined area (e.g., light projectors 402-1, 402-2, 402-3 and 402-4, as shown in FIG. 4D), and one or more output generators (e.g., output generators 270 and/or electronic display 215, as shown in FIG. 2) configured to, in conjunction with receiving the light projected from the one or more light projectors, provide a signal to a user.

In some embodiments, the one or more output generators of the head-mounted display device include one or more of: an audio output generator, a tactile output generator, and a display device. For example, as shown in FIG. 2, display device 205 includes electronic display 215 and output generators 270 (e.g., an audio output generators and/or a tactile output generator).

In some embodiments, the optical sensor of the head-mounted display device includes one or more of a camera and a photodiode (e.g., optical sensor 222 includes one or more cameras, one or more photodiodes or a combination thereof). In some embodiments, the optical sensor further includes one or more filters.

In some embodiments, the head-mounted display device further includes one or more processors configured to determine that the head-mounted display device has reached the boundary of the predefined area (e.g., display device 205 includes one or more processors 216, as shown in FIG. 2).

In some embodiments, the one or more processors of the head-mounted display device are configured to determine that the head-mounted display device has reached the boundary of the predefined area based on an intensity of the light from the one or more light projectors (e.g., FIG. 4B).

In some embodiments, the one or more processors of the head-mounted display device are configured to determine that the head-mounted display device has reached the boundary of the predefined area based on one or more wavelengths of the light from the one or more light projectors (e.g., FIG. 4B).

In some embodiments, the head-mounted display device further includes a communication device (e.g., communication device 260, as shown in FIG. 2) configured to transmit information identifying an intensity of the light from the one or more light projectors, detected by the optical sensor, and to receive information indicating whether the head-mounted display has reached the boundary of the predefined area (e.g., the head-mounted display device transmits to a console the information identifying the intensity of the light detected by the optical sensor and, after the console determines whether the head-mounted display device has reached the boundary of the predefined area, receives from the console information indicating whether the head-mounted display device has reached the boundary of the predefined area).

In accordance with some embodiments, a system (e.g., system 400, as shown in FIG. 4A) includes one or more light projectors projecting light defining a predefined area (e.g., one or more of light projectors 402-1, 402-2, 402-3, 402-4, and 500) and the head-mounted display device described above (e.g., display device 420).

In some embodiments, the one or more light projectors of the system include one or more of a laser and a light emitting diode. For example, in some embodiments, each of light projectors 402-1, 402-2, 402-3, 402-4, and 500 includes one or more lasers, one or more light emitting diodes, or some combination thereof.

In some embodiments, the one or more light projectors include a first light projector configured to project a first light defining a first boundary of the predefined area, and the one or more light projectors include a second light projector configured to project a second light defining a second boundary of the predefined area (e.g., FIG. 4A).

In some embodiments, the one or more light projectors include a light projector configured to project light having a shape corresponding to the predefined area. For example, in FIG. 5, light projector 500 is configured to project light having a rectangular shape corresponding to the rectangular predefined area.

The foregoing description, for purpose of explanation, has been described with reference to specific embodiments. However, the illustrative discussions above are not intended to be exhaustive or to limit the scope of the claims to the precise forms disclosed. Many modifications and variations are possible in view of the above teachings. For example, several of the components described herein can be included in a single display device and several features described herein can be implemented in the single display device. In some other embodiments, the display device is implemented without one or more functions described above (e.g., the one or more processors forgo projecting one or more portions of a transformed image and instead project a non-transformed image).

In some embodiments, a method for guiding a user wearing a head-mounted display device with a wide-angle light source (e.g., a light source configured to emit light at an angle greater than 90 degrees) includes detecting with an optical sensor that is located remotely from the head-mounted display device light emitted by the wide-angle light source. The optical sensor is configured to detect light within a narrow field of view (e.g., light received within 20 degree, 15 degree, 10 degree, or 5 degree field of view). The method also includes, in conjunction with receiving the light projected from the wide-angle light source at the optical sensor, providing a signal to the user.

In some embodiments, a system includes one or more optical sensors configured to detect a light within a narrow field of view and a head-mounted display device with a wide-angle light source. In some embodiments, the head-mounted display device also includes one or more output generators configured to, in conjunction with an optical sensor receiving the light projected from the wide-angle light source, provide a signal to a user. In some embodiments, the one or more output generators are located remotely from the head-mounted display device.

For brevity, such details are omitted herein, because a person having ordinary skill in the art would recognize various modifications based on the description in this application.

The embodiments were chosen in order to best explain the principles underlying the claims and their practical applications, to thereby enable others skilled in the art to best use the embodiments with various modifications as are suited to the particular uses contemplated.

What is claimed is:

1. A method for guiding a user wearing a head-mounted display device with one or more optical sensors, the method comprising:
detecting, with an optical sensor of the one or more optical sensors, light defining a predefined area from one or more light projectors; and
in conjunction with detecting the light projected from one or more light projectors, providing a signal to the user.

2. The method of claim 1, including:
projecting the light defining the predefined area using the one or more light projectors.

3. The method of claim 2, including:
projecting a first light from a first light projector of the one or more light projectors defining a first boundary of the predefined area; and
projecting a second light from a second light projector, distinct from the first light projector, of the one or more light projectors defining a second boundary, distinct from the first boundary, of the predefined area.

4. The method of claim 3, including:
detecting with the one or more optical sensors the first light defining the first boundary of the predefined area;
in response to detecting the first light defining the first boundary of the predefined area, providing a first signal to the user;
detecting with the one or more optical sensors, the second light defining the second boundary of the predefined area; and
in response to detecting the second light defining the second boundary of the predefined area, providing to the user a second signal that is distinct from the first signal.

5. The method of claim 3, including:
projecting a third light from a third light projector, distinct from the first light projector and the second light projector, of the one or more light projectors defining a third boundary, distinct from the first boundary and the second boundary, of the predefined area.

6. The method of claim 2, including:
projecting a first light from a first light projector of the one or more light projectors defining a first boundary of the predefined area;
projecting a third light from a third light projector, distinct from the first light projector, of the one or more light projectors defining a third boundary, distinct from the first boundary, of the predefined area;
detecting with a first optical sensor of the one or more optical sensors the first light defining the first boundary of the predefined area;
in response to detecting the first light defining the first boundary of the predefined area, providing a first signal to the user; and
detecting with a second optical sensor of the one or more optical sensors, distinct from the first optical sensor, the third light defining the third boundary of the predefined area; and
in response to detecting the third light defining the third boundary of the predefined area, providing a third signal to the user.

7. The method of claim 1, including:
determining that the head-mounted display device has reached a boundary of the predefined area.

8. The method of claim 7, including:
determining that the head-mounted display device has reached the boundary of the predefined area based on an intensity of the light from the one or more light projectors.

9. The method of claim 7, including:
determining that the head-mounted display device has reached the boundary of the predefined area based on one or more wavelengths of the light from the one or more light projectors.

10. A head-mounted display device, comprising:
an optical sensor configured to detect light, projected from one or more light projectors, defining a predefined area; and
one or more output generators configured to, in conjunction with detecting the light projected from the one or more light projectors, provide a signal to a user.

11. The head-mounted display device of claim 10, wherein:
the one or more output generators include one or more of: an audio output generator, a tactile output generator, and a display device.

12. The head-mounted display device of claim 10, wherein:
the optical sensor comprises one or more of a camera and a photodiode.

13. The head-mounted display device of claim 10, further comprising:
one or more processors configured to determine that the head-mounted display device has reached the boundary of the predefined area.

14. The head-mounted display device of claim 13, wherein:
the one or more processors are configured to determine that the head-mounted display device has reached the boundary of the predefined area based on an intensity of the light from the one or more light projectors.

15. The head-mounted display device of claim 13, wherein:
the one or more processors are configured to determine that the head-mounted display device has reached the boundary of the predefined area based on one or more wavelengths of the light from the one or more light projectors.

16. The head-mounted display device of claim 10, further comprising:
a communication device configured to:
transmit information identifying an intensity of the light from the one or more light projectors, detected by the optical sensor; and
receive information indicating whether the head-mounted display has reached the boundary of the predefined area.

17. A system, comprising:
one or more light projectors projecting light defining a predefined area; and
the head-mounted display device of claim 10.

18. The system of claim 17, wherein:
the one or more light projectors comprise one or more of a laser and a light emitting diode.

19. The system of claim 17, wherein:
the one or more light projectors include a first light projector configured to project a first light defining a first boundary of the predefined area; and
the one or more light projectors include a second light projector configured to project a second light defining a second boundary of the predefined area.

20. The system of claim 17, wherein:
the one or more light projectors include a light projector configured to project light having a shape corresponding to the predefined area.
